(19) United States
(12) Patent Application Publication
(10) Pub. No.: US 2025/0001626 A1
(43) Pub. Date: Jan. 2, 2025

(54) HAIR CUTTER

(71) Applicant: Braun GmbH, Kronberg (DE)

(72) Inventors: Thomas VERSTEGE, Frankfurt (DE); Jade ALEXANDER, Frankfurt (DE); Andreas ERNDT, Kelkheim (DE); Marvin Thorsten KNORR, Wiesbaden (DE)

(21) Appl. No.: 18/756,377

(22) Filed: Jun. 27, 2024

(30) Foreign Application Priority Data
Jun. 29, 2023 (EP) 23182300.6

(51) Int. Cl. B26B 19/04; B26B 19/06

(52) U.S. Cl. CPC B26B 19/046; B26B 19/063

(57) ABSTRACT

The present invention relates to a hair cutter such as electric shaver and/or electric trimmer, comprising a suspension spring mechanism including at least one elongated leaf spring which is rigidly attached, with one end portion, to a first end portion or edge portion of a cutter unit and, with another end portion, to a cutter head frame at a spring support portion thereof adjacent to a second end portion or edge portion of the cutter unit opposite to the first end portion or edge portion thereof. Despite such eccentric attachment of the leaf spring to the cutter unit and the asymmetric layout of the spring mechanism, the elastic support structure of the at least one cutter unit nevertheless may be configured to provide for a symmetric self-adaption, in particular symmetric micro diving and/or micro tilting.

### FIELD OF THE INVENTION

The present invention relates to cutting body hair such as beard stubbles. More particularly, the present invention relates to a hair cutter such as an electric shaver and/or trimmer, comprising a handle and a cutter head attached thereto, and at least one cutter unit including a pair of drivable and stationary cutter elements cooperating with each other, said cutter unit being adjustably supported by means of a support structure including a spring mechanism to allow for self-adaption of the cutter unit to the skin contour in terms of diving and/or tilting of the cutter unit relative to a cutter head frame, said spring mechanism including at least one elongated leaf spring.

### BACKGROUND OF THE INVENTION

Electric shavers and trimmers utilize various mechanisms to provide hair cutting functionality. Some electric shavers use one or more cutter units including a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter units including a pair of cooperating cutting elements with comb-like edges including one or more rows of comb-like or rake-like cutting teeth reciprocating or rotating relative to each other, are often used for cutting longer beard stubbles or problem hair that is difficult to cut due to, for example, a very small angle to the skin or growing from very resilient skin. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter units for longer hairs may be integrated into electric shavers or trimmers which at the same time may be provided with the aforementioned shear foil cutter units. For example, a cutter head may include one or two cutter units with comb-like cutting teeth and, for example, at opposite sides of such comb-like cutters a pair of cutting units of the shear foil type, wherein, however, other arrangements and combinations may be used.

Irrespective of the cutter type, a well-set and close-fitting skin contact without undue skin contact pressure helps to achieve an efficient cutting action and to avoid skin irritations, wherein a resilient support structure allowing for self-adaption of the cutter units to the skin contour may be used to achieve such goals. More particularly, so as to allow self-adaption of the cutter units to the skin contour, the entire cutter head may be movably supported by the handle head portion to allow swiveling and/or tilting and or diving of the cutter elements such as the shear foil and/or the comb-like blades relative to the handle head portion. Such swiveling and/or tilting of the cutter head allows the skin contact surface of the cutter head to smoothly follow the skin contour and compensate misalignment or misorientation of the handle.

To further improve self-adaption to the skin contour, the cutter units may be movably supported relative to a cutter head frame to allow for further adapting movements of the cutter units relative to the cutter head frame, in addition to or in the alternative to adapting movements of the entire cutter head relative to the handle. Such additional self-adaption in terms of movability of the cutter units relative to the cutter head frame is in particular helpful when more than one cutter unit is provided at the cutter head, wherein the support structure for movably supporting the cutter units relative to the cutter head frame may allow for individual movements of the cutter units relative to each other and relative to the cutter head frame. For example, when the cutter head is moved along an uneven or multi axially curved skin portion such as the chin, a leading cutter unit may contact a skin portion differently inclined or curved than a skin portion touched by a trailing cutter unit so a better adaption to the skin contour may be achieved when the leading cutter unit tilts or dives in a way different from tilting or diving of the trailing cutter unit.

For example, the support structure allowing for self-adaption movements of the cutter units relative to the cutter head frame may be configured to allow for diving of one or more cutter units along one or more diving axes substantially perpendicular to the skin contact surface of the cutter head and cutter units, respectively, and/or allow for tilting of one or more cutter units about one or more tilt axes extending substantially parallel to said skin contact surface and perpendicular to a longitudinal or main axis of the respective cutter unit. More particularly, such tilt axes may extend substantially perpendicular to the usual travelling axes of the cutter head along the skin surface when the hair cutter is used in a usual way to effect cutting action.

Such individual diving and/or tilting of the cutter units relative to the cutter head frame is sometimes called micro diving and micro tilting.

A problem with such micro-self-adjustment of the cutter units relative to the cutter head frame is related to the driving action. As mentioned before, the cutter units usually include a stationary cutter element and a drivable cutter element which is driven to reciprocate or rotatorily oscillate relative to the stationary cutter element. To improve efficiency of the transmission of the driving forces and/or driving torques, a stiff, rigid support of the stationary cutting element is desired with regard to the driving axis, so the stationary cutting element does not follow movements of the driven cutting element along said driving axis, whereas on the other hand the cutter unit including the stationary cutting element should be easily movable to tilt and/or dive with limited resistance and/or limited restoring forces to allow for light footed self-adaption. In other words, the support structure supporting the cutter units needs to fulfill quite diverging demands: With regard to the driving axis such as the reciprocation axis and/or the rotatory oscillation axis, the support structure should be stiff and rigid, whereas the support structure should be soft and resilient with regard to the tilt and/or dive axis.

Such underlying problem is intensified due to the fact that the drivable and stationary cutter elements cooperating with each other usually need some contact pressure and/or closeness to each other to achieve efficient shearing and cutting of the hair stubbles. Usually, a biasing mechanism is provided for urging the cooperating cutter elements against each other, wherein the biasing mechanism should not impair the self-adaption movements.

Sometimes, such biasing mechanism includes a spring mechanism applying a spring force onto one of the cutting elements to urge it against the other cutter element cooperating therewith. On the other hand, as mentioned before, the stationary cutter element should be held rigidly against movements along or about the driving axis of the driving mechanism to achieve efficient driving. So as to compensate the resilience of the aforementioned spring mechanism which is usually given also in the direction of the transmission of the driving forces and/or driving torque, the support structure usually includes additional support elements such as guide pins received in slot-like pockets to fixedly hold the stationary cutter element in the direction of the driving movements such as reciprocating movements but allowing for tilting and/or diving. So as to make the support structure rigid with regard to undesired play in the direction of the transmission of driving forces/torque, such guide pins should have a tight fit in such pockets, whereas, however, such tight fit makes the support structure sluggish and rough running with regard to self-adaption movements such as diving and/or tilting.

In addition, an underlying problem is noise of the drive train which also needs to allow for the self-adaption movements of the cutter units, wherein a sphere-shaped or cone-like drive pin may be received in a spherical or cone-shaped recess to allow for multi-axial pivoting, but still transmitting driving forces perpendicular thereto. When a cone-shaped drive pin matches a cone-shaped recess, the recess may have a larger opening angle than the drive pin to form a pivoting joint. Sometimes, the biasing mechanism for biasing the cooperating cutter elements against each other, may be incorporated into or associated with such pivotable drive train joint. More particularly, a biasing element such as a spring may be provided to urge the sphere-shaped or cone-line drive pin into the corresponding recess to achieve a reliable connection for transmission of forces and, at the same time, bias the drivable cutter element against the stationary cutter element. Such biasing of the drive train joint to achieve, at the same time, biasing of the cutter elements against each other, may be, however, detrimental to the desired light footedness of self-adaption, whereas on the other hand, when the biasing forces are reduced, vibrations and rattling noises due to micro-play in the transmission train may occur.

For example, document U.S. Pat. No. 3,950,847 B discloses a hair cutter in terms of a dry shaver having a reciprocating drive cutter that cooperates with a stationary counter cutter, the latter being resiliently mounted on a stationary part of the drive shaver housing and urged against the driven cutter. More particularly, the stationary shear foil is supported at the cutter head frame by means of a leaf spring which is connected, with its distal end portions, to the cutter head frame and, with a center portion, to a shear foil carrier. A transmitter for transmitting driving forces/torque from a motor to the drivable cutter elements extends through a recess in said leaf spring and is connected to the drivable cutter element.

### SUMMARY OF THE INVENTION

It is an objective underlying the present invention to provide for an improved hair cutter avoiding at least one of the disadvantages of the prior art and/or further developing the existing solutions. A more particular objective underlying the invention is to provide for a good adaption of the cutter system to the skin contour. Another objective underlying the present invention is to provide for an improved suspension of the cutter units to allow for light footed, individual micro-self-adaption of the cutter units to the skin contour and at the same time, achieve efficient driving of the cooperating cutter elements relative to each other. In particular, self-adaption of the cutter units to the skin contour with low skin contact pressure should be achieved without sacrificing efficient transmission of driving forces to avoid rattling noises and vibrations.

According to an aspect, the spring mechanism of the support structure that allows self-adaption of the at least one cutter unit to the skin contour, includes an elongated leaf spring holding the at least one cutter unit at the cutter head frame in an elastic way to allow for self-adaption of the cutter unit to the skin contour and stiffening the suspension of the cutter unit with regard to the driving motion of the drivable cutter element relative to the stationary cutter element to improve driving efficiency and vibrations. More particularly, said leaf spring is rigidly attached, with one end portion, to a first end portion or edge portion of said cutter unit and, with another end portion, to said cutter head frame at a spring support portion thereof adjacent to a second end portion or edge portion of the cutter unit opposite to the aforementioned first end portion or edge portion thereof. The leaf spring may extend, from its fixation point at the cutter head frame, across or along the cutter unit to hold said cutter unit at an end/edge portion at the opposite side away from the leaf spring fixation point at the cutter head. Due to the rigid attachment at both end portions, the leaf spring stabilizes the cutter unit with regard to driving motions of the drivable cutter element relative to this stationary cutter element, whereas at the same time self-adaption movements are allowed by means of bending the leaf spring.

More particularly, said leaf spring may form a sort of double cantilever support structure for the cutter unit, wherein the leaf spring itself is cantilevered at the cutter head frame and forms a cantilever, beam-like element projecting from the cutter head frame and is fixedly attached thereto. On the other hand, the cutter unit is cantilevered at the opposite end portion of the leaf spring and forms a sort of cantilevered element projecting from the leaf spring and fixedly attached thereto.

In a side view with a viewing axis parallel to a tilt axis, the leaf spring together with the cutter unit and the cutter head frame attached to opposite ends of the leaf spring may form a z-shaped support structure allowing for diving and tilting of the cutter unit relative to the cutter head frame along a diving axis and about a tilt axis due to elastic bending of the leaf spring, whereas said leaf spring may substantially rigidly hold the cutter unit in a direction perpendicular to the diving axis and to the tilt axis, thereby increasing driving efficiency. More generally, the support structure including the leaf spring may form an eccentric structure holding the cutter unit elastically relative to the cutter head frame, wherein movements of the cutter head unit necessitate bending of the leaf spring due to rigidly attaching the end portions of the leaf spring to the cutter head frame on the one head and to the cutter unit on the other hand.

Such leaf spring support structure is particularly advantageous in that a low number of parts is sufficient to suspend the cutter unit in a self-adaptive way, wherein the support structure may have a soft, elastic and resilient characteristic with regard to self-adaption movements, thereby achieving good contour adaption without necessitating high skin contact pressure, and at the same time a stiff support of the cutter unit with regard to driving motions with no or very little play, thereby avoiding losses in the transmission of driving forces/torque and vibration amplitude and furthermore, avoiding rattling noise and vibrations.

The diving axis and tilt axis for micro-diving and micro-tilting of the at least one cutter unit relative to the cutter head frame, may extend substantially perpendicular to each other, wherein the suspension structure may be configured to allow translation of the cutter unit along said diving axis and rotation or rotatory tilting about the tilt axis. The dive axis may extend substantially perpendicular to a skin contact surface of the cutter head touching the skin to be treated, and more or less parallel to a longitudinal handle axis, depending on the inclination of the cutter head to the handle as the the cutter head may have a variably or constantly cranked orientation relative to the handle. The tilt axis may extend substantially parallel to the skin contact surface and more particularly, parallel to the direction of strokes moving the hair cutter over the skin surface in a sort of natural behavior. In addition, or in the alternative, the tilt axis may extend parallel to a virtual plane containing the longitudinal axis of the handle and being substantially parallel to the natural, usually reciprocating shaving movements. For example, when the cutter head has a leading edge and a trailing edge moved along the skin to be shaved, said tilt axis may extend perpendicular to said leading edge and trailing edge. When the cutter head has, roughly speaking a rectangular layout with a main axis along the “longer edges”, the tilt axis may extend perpendicular to such main axis.

In addition to the micro diving and/or micro tilting of the cutter unit relative to the cutter head frame an enabled by said leaf spring, the cutter head in its entirety may be movably supported relative to the handle to allow for rotatory self-adjustment of the cutter head to the skin contour to be shaved or trimmed. More particularly, the support structure connecting the cutter head to the handle head portion is provided with at least one rotatory degree of freedom allowing for rotatory movements of the cutter head relative to the handle head portion about at least one axis of rotation perpendicular to the longitudinal axis of the handle.

More particularly, the support structure connecting the cutter head to the handle head portion may include a swivel axis allowing for swiveling of the cutter head relative to the handle head portion and a tilting axis allowing for tilting of the cutter head relative to the handle head portion. Said swiveling and tilting axes may extend substantially perpendicular to each other and, at the same time, substantially perpendicular to the longitudinal axis of the handle head portion and/or substantially parallel to a skin contact surface of the cutter head. Said tilt axis may extend substantially parallel to a plane containing the longitudinal axis of the handle and being substantially parallel to the natural, usually reciprocating shaving movements. For example, when the cutter head has a leading edge and a trailing edge moved along the skin to be shaved, said tilt axis may extend perpendicular to said leading edge and trailing edge. On the other hand, said swivel axis may extend perpendicular to the direction in which the cutter head is moved along the skin to be shaved and thus, substantially parallel to said trailing edge and leading edge.

These and other advantages become more apparent from the following description giving reference to the drawings and possible examples.

### BRIEF DESCRIPTION OF THE DRAWINGS

FIG. 1: a perspective view of a hair cutter having a cutter head attached to a handle, wherein said cutter head includes shear foil type cutter units as well as comb-like cutter units which are individually supported for micro tilting and micro diving relative to a cutter head frame,

FIG. 2: an exploded, perspective view of the cutting system of the cutter head including a pair of comb-like cutter units for long hair or problem hair in the center and a pair of cutter units of the shear foil type at outer portions of the cutter head, each of said cutter units comprising a pair of drivable and stationary cutter elements cooperating with each other and reciprocating relative to each other along drive axes substantially parallel to a longer side edge of the cutter head, wherein the exploded view shows the leaf springs supporting each of the cutter units individually relative to the cutter head frame,

FIG. 3: a schematic side view of the hair cutter of FIG. 1 in a skeletal illustration showing the drive train transmitting driving action from a motor in the handle to the drivable cutter element of a cutter unit of the cutter head, wherein the cutter unit is elastically supported by a leaf spring,

FIG. 4: a perspective view of a leaf spring for supporting one of the outer cutter units of the cutter head of the hair cutter of FIG. 1, wherein the leaf spring is shown to have end portions with attachment means for rigidly attaching the end portions to the cutter unit on the one hand and the cutter head frame on the other hand, and furthermore a stiffened center portion of increased thickness and two bending portions of reduced thickness arranged adjacent to each one of the aforementioned end portions,

FIG. 5: a perspective view of a pair of leaf springs for elastically supporting the cutter units in the center of the cutter head of the hair cutter of FIG. 1, wherein said leaf springs have a common attachment portion for attachment to the cutter head frame, said attachment portion connecting the leaf springs at end portions thereof,

FIG. 6a: a side view of the leaf springs of FIGS. 4 and 5 mounted to the cutter units and the cutter head frame, wherein the leaf spring of FIG. 4 is supporting a short hair cutter unit of the shear foil type relative to the cutter head frame,

FIG. 6b: a perspective view of the leaf springs of FIGS. 4 and 5 mounted to the cutter units and the cutter head frame, wherein the leaf spring of FIG. 5 are supporting two short hair cutter units the shear foil type relative to the cutter head frame,

FIG. 6c: a side view of the leaf springs of FIGS. 4 and 5 mounted to the cutter units and the cutter head frame, wherein the leaf spring of FIG. 4 is supporting a long hair cutter unit of relative to the cutter head frame,

FIG. 6d: a perspective view of the leaf springs of FIGS. 4 and 5 mounted to the cutter units and the cutter head frame, wherein the leaf spring of FIG. 5 is supporting the long hair cutter units relative to the cutter head frame,

FIG. 7a: a cross sectional side view of the leaf springs of FIGS. 4 and 5 mounted to the cutter units similar to FIG. 6a, to illustrate the arrangement and attachment of the leaf spring to the short hair cutting unit,

FIG. 7b: a perspective view of the leaf springs of FIGS. 4 and 5 mounted to the cutter units similar to FIG. 6b, to illustrate the arrangement and attachment of the leaf spring,

FIG. 7c: a cross sectional side view of the leaf springs of FIGS. 4 and 5 mounted to the cutter units similar to FIG. 6c, to illustrate the arrangement and attachment of the leaf spring relative to a long hair cutting unit,

FIG. 7d: a perspective view of the leaf springs of FIGS. 4 and 5 mounted to the cutter units similar to FIG. 6d, illustrate the arrangement and attachment of the leaf spring relative to the long hair cutting units,

FIG. 8a: a cross sectional view of the leaf spring support structure illustrating the rigidity of the leaf spring against translatory movements of the cutter unit along axis x, i.e. in a plane parallel to the skin contact surface of the cutter head,

FIG. 8b: a cross sectional view of the leaf spring support structure illustrating the rigidity of the leaf spring against translatory movements of the cutter unit along axis y, i.e. in a plane parallel to the skin contact surface of the cutter head,

FIG. 9a: a cross sectional view of the leaf spring support structure and of a cutter unit similar to FIGS. 8a and 8b, illustrating the elasticity of the leaf spring to allow for diving of the cutter unit along a diving axis perpendicular to the skin contact surface, with cutting unit being elevated here,

FIG. 9b: a cross sectional view of the leaf spring support structure of a cutter unit similar to FIG. 9a but in pushed down status, but illustrating the elasticity of the leaf spring to allow for diving of the cutter unit along a diving axis perpendicular to the skin contact surface, wherein a comparison of partial views 9a and 9b show the diving translation of the cutter unit along diving axes z, and furthermore the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9b with partial views 9e, 9f, 9g shows that the leaf spring may have different configurations in the neutral position in terms of negative and positive inclinations,

FIG. 9c: a perspective view of the leaf spring support structure of a cutter unit similar to FIG. 8a or 9a, but illustrating the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9b with partial views 9e, 9f, 9g shows that the leaf spring may have different configurations in the neutral position in terms of negative and positive inclinations,

FIG. 9d: a cross sectional view of the leaf spring support structure of a cutter unit similar to FIG. 7c, but illustrating the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9b with partial views 9e, 9f, 9g shows that the leaf spring may have different configurations in the neutral position in terms of negative and positive inclinations,

FIG. 9e: a schematic cross sectional view of the leaf spring support structure of a cutter unit similar to FIG. 8a, but illustrating the elasticity of the leaf spring to allow for diving of the cutter unit along a diving axis perpendicular to the skin contact surface, wherein a comparison of partial views 9a and 9 b show the diving translation of the cutter unit along diving axes z, and furthermore the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9 b with partial views 9e,9f, 9g shows that the leaf spring may have different configurations in the neutral position in terms of negative and positive inclinations,

FIG. 9f: a schematic cross sectional view of the leaf spring support structure of a cutter unit similar to FIG. 9e, but illustrating the elasticity of the leaf spring to allow for diving of the cutter unit along a diving axis perpendicular to the skin contact surface, wherein a comparison of partial views 9 a and 9b show the diving translation of the cutter unit along diving axes z, and furthermore the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9b with partial views 9e, 9f, 9g shows that the leaf spring may have different configurations in the neutral position in terms of negative and positive inclinations,

FIG. 9g: a schematic cross sectional view of the leaf spring support structure of a cutter unit similar to FIG. 9e, but illustrating the elasticity of the leaf spring to allow for diving of the cutter unit along a diving axis perpendicular to the skin contact surface, wherein a comparison of partial views 9a and 9b show the diving translation of the cutter unit along diving axes z, and furthermore the rigidity of the leaf spring support structure against rotatory movements of the cutter units about a swivel axis x extending substantially parallel to the driving axes of the cutter elements, wherein in addition to the leaf spring anti-rolling pins blocking rotation about said swivel axis x are shown, cf. partial views 9c and 9d, wherein a comparison of partial views 9a, 9b with partial views 9e, 9f, 9g shows that the leaf spring may have different configurations in the neutral position in terms of negative and positive inclinations,

FIG. 9h: a cross sectional view 9h through a shaver head having a further spring around the drive pin for controlling diving of the cutter unit in addition to the leaf spring,

FIG. 10a: a side view of the leaf spring support structure, wherein partial views 10a, 10b and 10c illustrate tilting of the cutter unit about tilt axis y by means of elastically bending the leaf spring, and partial views 10d and 10e illustrate rigidity of the leaf spring support structure against rotatory movements of the cutter units about diving axes z, said support structure having anti-rolling pins preventing such rotation,

FIG. 10b: a cross sectional view of the leaf spring support structure, wherein partial views 10a, 10b and 10c illustrate tilting of the cutter unit about tilt axis y by means of elastically bending the leaf spring, and partial views 10d and 10e illustrate rigidity of the leaf spring support structure against rotatory movements of the cutter units about diving axes z, said support structure having anti-rolling pins preventing such rotation,

FIG. 10c: a side view of the leaf spring support structure, wherein partial views 10a, 10b and 10c illustrate tilting of the cutter unit about tilt axis y by means of elastically bending the leaf spring, and partial views 10d and 10e illustrate rigidity of the leaf spring support structure against rotatory movements of the cutter units about diving axes z, said support structure having anti-rolling pins preventing such rotation,

FIG. 10d: a perspective view of the leaf spring support structure, wherein partial views 10a, 10b and 10c illustrate tilting of the cutter unit about tilt axis y by means of elastically bending the leaf spring, and partial views 10d and 10e illustrate rigidity of the leaf spring support structure against rotatory movements of the cutter units about diving axes z, said support structure having anti-rolling pins preventing such rotation, and

FIG. 10e: a cross sectional views of the leaf spring support structure, wherein partial views 10a, 10b and 10c illustrate tilting of the cutter unit about tilt axis y by means of elastically bending the leaf spring, and partial views 10d and 10e illustrate rigidity of the leaf spring support structure against rotatory movements of the cutter units about diving axes z, said support structure having anti-rolling pins preventing such rotation.

### DETAILED DESCRIPTION OF THE INVENTION

So as to allow for more comfortable shaving and/or trimming with improved adaption of the cutter units to the skin contour, an improved support structure is suggested to reduce skin contact pressure necessary to effect adaption, and, at the same time, to allow for efficient driving of the cooperating cutter elements with low mechanical losses and less noise.

More particularly, it is suggested that the swing mechanism of the support structure that allows self-adaption of the at least one cutter unit to the skin contour, includes an elongated leaf spring holding the at least one cutter unit at the cutter head frame in an elastic way to allow for self-adaption of the cutter unit to the skin contour and stiffening the suspension of the cutter unit with regard to the driving motion of the drivable cutter element relative to the stationary cutter element to improve driving efficiency and vibrations. More particularly, said leaf spring is rigidly attached, with one end portion, to a first end portion or edge portion of said cutter unit and, with another end portion, to said cutter head frame at a spring support portion thereof adjacent to a second end portion or edge portion of the cutter unit opposite to the aforementioned first end portion or edge portion thereof. The leaf spring may extend, from its fixation point at the cutter head frame, across or along the cutter unit to hold said cutter unit at an end/edge portion at the opposite side away from the leaf spring fixation point at the cutter head. Due to the rigid attachment at both end portions, the leaf spring stabilizes the cutter unit with regard to driving motions of the drivable cutter element relative to this stationary cutter element, whereas at the same time self-adaption movements are allowed by means of bending the leaf spring.

More particularly, said leaf spring may form a sort of double cantilever support structure for the cutter unit, wherein the leaf spring itself is cantilevered at the cutter head frame and forms a cantilever, beam-like element projecting from the cutter head frame and is fixedly attached thereto. On the other hand, the cutter unit is cantilevered at the opposite end portion of the leaf spring and forms a sort of cantilevered element projecting from the leaf spring and fixedly attached thereto.

In a side view with a viewing axis parallel to a tilt axis, the leaf spring together with the cutter unit and the cutter head frame attached to opposite ends of the leaf spring may form a z-shaped support structure allowing for diving and tilting of the cutter unit relative to the cutter head frame along a diving axis and about a tilt axis due to elastic bending of the leaf spring, whereas said leaf spring may substantially rigidly hold the cutter unit in a direction perpendicular to the diving axis and to the tilt axis, thereby increasing driving efficiency. More generally, the support structure including the leaf spring may form an eccentric holding the cutter unit elastically relative to the cutter head frame, wherein movements of the cutter head unit necessitate bending of the leaf spring due to rigidly attaching the end portions of the leaf spring to the cutter head frame on the one head and to the cutter unit on the other hand.

Such leaf spring support structure is particularly advantageous in that a low number of parts is sufficient to suspend the cutter unit in a self-adaptive way, wherein the support structure may have a soft, elastic and resilient characteristic with regard to self-adaption movements, thereby achieving good contour adaption without necessitating high skin contact pressure, and at the same time a stiff support of the cutter unit with regard to driving motions with no or very little play, thereby avoiding losses in the transmission of driving forces/torque and vibration amplitude and furthermore, avoiding rattling noise and vibrations.

The spring mechanism of the support structure enabling micro diving and/or micro tilting of the at least one cutter unit, basically could include a pair of leaf springs which may be arranged in an x-like configuration, wherein the two leaf springs could be rigidly attached to opposite end portions or edge portions of the cutter unit on the one hand and two portions of the cutter head frame opposite to each other and adjacent to the opposite end/edge portions of the cutter unit. Both leaf springs can bend to allow for micro diving and/or micro tilting of the cutter unit relative to the cutter head frame. Such double leaf spring arrangement can form a symmetrical suspension structure for elastically suspending the cutter unit at the cutter head frame.

In the alternative, however, the support structure, and more particularly the spring mechanism thereof, can be an asymmetric one, wherein only one leaf spring may be provided so that only one end portion or edge portion of the cutter unit is mounted to a leaf spring and/or elastically held by a spring.

Despite such eccentric attachment of the leaf spring to the cutter unit and the asymmetric layout of the spring mechanism, the elastic support structure of the at least one cutter unit nevertheless may be configured to provide for a symmetric self-adaption, in particular symmetric micro diving and/or micro tilting. The leaf spring may provide for the same tilt resistance and/or same dive resistance for both right and left cutter unit portions. More particularly, the leaf spring may be configured such that the cutter unit, despite the eccentric attachment of the leaf spring to the cutter unit, dives along a diving axis without tilting about a tilt axis when the cutter unit is subject to skin contact pressure represented by a resultant skin contact force going through the center of the cutter unit. In other words, when a skin contact force is supplied to the center of the skin contact surface of the cutter unit, the cutter unit does not tilt to the left side or to the right side, but dives translationally or uniformly at both ends, i.e. opposite end portions of the cutter unit dive the same distance.

Since self-adaption movements of the cutter unit relative to the cutter frame go along with bending of the leaf spring, the bending characteristic of the leaf spring may be configured such that the response of the cutter unit to skin contact pressure in terms of micro diving and/or micro tilting movements is symmetric and/or proportional or corresponding to the distribution of the skin contact pressure along the skin contact surface of the cutter unit. When the resultant skin contact force goes through the center, the cutter unit dives translationally without tilting. When the resultant skin contact force goes through a right side portion of the cutter unit, the cutter unit may dive and tilt clockwise or only tilt clockwise. On the other hand, when the resultant skin contact force goes through a left side portion of the cutter unit, there may be diving and counter-clockwise tilting or only counter-clockwise tilting.

The leaf spring may have bending portion adjacent to the end portions of the leaf spring which are attached to the cutter head and the cutter unit, respectively, wherein said bending portions may provide for substantially identical bending stiffnesses and have substantially the same length. More particularly, such bending portions may be arranged symmetrical and may provide for identical bending characteristics of the leaf spring in the leaf spring region neighboring the cutter unit and/or the cutter unit attachment point on the one hand and neighboring the cutter head and/or cutter head attachment point on the other hand.

Between such bending portions adjacent to the leaf spring attachment points, the leaf spring may include a center portion separating said bending portions and configured to have a more rigid characteristic than the bending portions.

More particularly, said center portion of the leaf spring may have a center thickness larger than the thicknesses of the bending portions. In addition, or in the alternative to such increased center thickness, the center portion may have a center width which is larger than the width of the bending portions of the leaf spring. Due to increased center thickness and/or increased center width, the center portion is significantly more rigid and/or stiffer than the bending portions so bending of the leaf spring due to skin contact pressure of the cutter unit occurs at well-defined portions and/or positions so micro diving and/or micro tilting of the cutter unit due to bending of the leaf spring is well-controlled.

To increase bending stiffness of the center portion, one or more reinforcement ribs may be provided at such center portion to increase thickness and/or width of said center portion.

The leaf spring may be configured to be active along the entire diving path of the cutter unit and/or control diving movement of the cutter unit along the entire diving path. More particularly, the leaf spring may be configured to provide for a diving restoring force trying to restore the cutter unit into its neutral/starting position after having been diving, wherein such restoring force may have a characteristic proportional to the diving path, i.e. the restoring force may increase constantly with increasing diving movement. The leaf spring may provide for a restoring force larger than zero even when the cutter unit is in its home or starting position so at least some skin contact pressure is necessary to start diving of the cutter unit, wherein the restoring force may continuously increase the deeper the cutting unit dives. However, other restoring force characteristics are possible, for example in terms of a non-linear increase over diving path.

The leaf spring may be the only spring providing for a restoring force counteracting diving. In the alternative, the spring mechanism may include one or more further springs counteracting diving movements. More particularly, at least one further spring may be provided for adjusting the restoring force characteristic provided by the leaf spring. For example, such further spring may be configured to be active only for a portion of the diving path of the cutter unit. More particularly, such further spring may be inactive and/or provide for no restoring force when the cutter unit is in its neutral/starting position and/or has not yet dived, and/or may be inactive along a first part of the diving path available to the cutter unit. In other words, such further spring may be configured to become active only after the cutter unit has started diving over a certain distance out of the neutral/starting position.

For example, the further spring may be out of engagement with the cutter unit and/or out of engagement with the cutter head frame, as long as the cutter unit is in its neutral/starting position and/or has not yet dived a certain distance, and/or a gap or play may be provided between the further spring and the cutter unit when the cutter unit is in its neutral/starting position.

Such further spring may be configured to provide for only a restoring force counteracting diving, but not counteracting tilting movements. For example, the further spring may be in engagement with a central portion of the cutter unit.

So as to have a soft and resilient suspension characteristic with regard to the desired self-adaption movements of the cutter unit and, at the same time, a rigid and stiff support characteristic with regard to the direction of driving movements of the drivable and stationary cutter elements relative to each other on the other hand, the leaf spring may be inclined relative to the skin contact surface of the cutter unit and/or to the driving axes along which the cutter elements reciprocate or move relative to each other, at a relatively small angle of inclination which, in some diving/tilting position, even may become zero. More particularly, when the cutter unit has not yet dived and/or is still in its neutral or starting position not subject to any skin contact pressure, the leaf spring, with its longitudinal axis, and/or a virtual connection line going through the end portions of the leaf spring may extend at an acute angle to a virtual plane perpendicular to the diving axis and/or parallel to the skin contact surface of the cutter head, wherein such acute angle may be less than 30° or less than 20° or less than 10°, wherein it is also an option that the acute angle is 0 in the aforementioned starting position of the cutter unit so, in other words, the leaf spring may extend parallel to the skin contact surface before diving has started.

Depending on the configuration of the cutter unit and/or the accommodation environment, the leaf spring may be inclined at a negative acute angle or at a positive acute angle, when the cutter unit is in its neutral/starting position. In other words, the leaf spring's connections point to the cutter unit may be higher or lower than the leaf spring's connection point to the cutter head frame, wherein higher or lower or more generally, the height dimension may be considered in a direction perpendicular to the skin contact surface of the cutter head. In other words, the leaf spring's connections point to the cutter unit may be closer to or further away from the skin contact surface or than the leaf spring's connection point to the cutter head frame, when the cutter unit is in its home position. According to another option, the leaf spring's connection points to the cutter unit and to the cutter head frame, respectively, may be arranged at the same height and/or the same distance away from the skin contact surface when the cutter head is in its neutral/starting position.

The leaf spring may have a straight longitudinal axis, wherein in such case the aforementioned virtual connection line going through the end portions of the leaf spring coincides with such straight longitudinal axis. However, it is basically possible that the leaf spring has one or more curved portions and/or one or more angled portions so the longitudinal axis may have a curved and/or angled configuration. In such case, the aforementioned virtual line connecting the end portions of the leaf spring is not co-incident with the longitudinal axis.

Nevertheless, so as to have a stiff and rigid configuration of the leaf spring with regard to driving movements, the leaf spring may have a straight longitudinal axis almost parallel to or only slightly inclined relative to the driving axis so the leaf spring shows significant resistance against reaction forces implied by the driving movements of the cutter elements.

The driving axes of the cutter elements may extend substantially parallel to the skin contact surface, in particular when the cutter elements have an elongated configuration, wherein the cutter elements may reciprocate relative to each other along such driving axis. Basically, the driving axis also may extend substantially perpendicular to the skin contact surface to allow for rotation of the cooperating cutter elements relative to each other, for example in terms of rotatory oscillation.

So as to help the leaf spring in holding the cutter unit in a stiff and rigid way with regard to driving forces, the leaf spring may be arranged in a common plane containing the driving axis and the longitudinal leaf spring axis. In other words, a skew-whiff arrangement of the leaf spring with regard to the driving axes may be avoided. More particularly, the leaf spring, with its longitudinal axes, may extend in a virtual plane containing the driving axes of the cutter elements and/or perpendicular to the skin contact surface and/or containing the diving axes.

More particularly, although the longitudinal axis of the leaf spring may extend in such virtual plane, the leaf spring, with its width direction, may be arranged substantially perpendicular to the virtual plane so that movements of the leaf spring due to bending thereof occur substantially parallel to such virtual plane.

In addition to the described self-adaption movements of the cutter unit relative to the cutter head frame in terms of the aforementioned micro diving and/or micro tilting, the cutter head in its entirety may be movably supported relative to the handle to allow for rotatory self-adjustment of the cutter head to the skin contour to be shaved or trimmed. More particularly, the support structure connecting the cutter head to the handle head portion is provided with at least one rotatory degree of freedom allowing for rotatory movements of the cutter head relative to the handle head portion about at least one axis of rotation perpendicular to the longitudinal axis of the handle.

More particularly, the support structure connecting the cutter head to the handle head portion may include a swivel axis allowing for swiveling of the cutter head relative to the handle head portion and a tilting axis allowing for tilting of the cutter head relative to the handle head portion. Said swiveling and tilting axis may extend substantially perpendicular to each other and, at the same time, substantially perpendicular to the longitudinal axis of the handle head portion and/or substantially parallel to a skin contact surface of the cutter head. Said tilt axis may extend substantially parallel to a plane containing the longitudinal axis of the handle and being substantially parallel to the natural, usually reciprocating shaving movements. For example, when the cutter head has a leading edge and a trailing edge moved along the skin to be shaved, said tilt axis may extend perpendicular to said leading edge and trailing edge. On the other hand, said swivel axis may extend perpendicular to the direction in which the cutter head is moved along the skin to be shaved and thus, substantially parallel to said trailing edge and leading edge.

The cutter head may be urged by a restoring mechanism towards a neutral and/or starting position when no skin contact pressure is applied to the cutter head, wherein such restoring mechanism may include a biasing mechanism or spring mechanism applying a biasing force and/or biasing torque trying to restore the starting position of the cutter head relative to the handle. Such restoring forces need to be overcome by skin contact pressure to have tilting and/or swiveling and/or diving.

Such biasing mechanism of the restoring mechanism may include a spring device configured deflectable from a resting position or home position into opposite directions, wherein deflection into each of said opposite directions creates a restoring force back towards the home position. Depending on the direction of twisting and thus, the direction of deflection of the spring device, restoring forces into opposite directions are created.

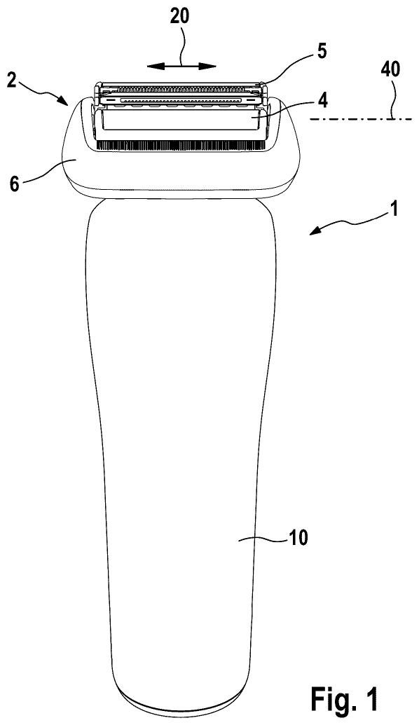

As can be seen from FIG. 1, the hair cutter 1 may be configured as an electric shaver and/or electric trimmer having one or more cutter units 3 which may be part of a cutter head 2 attached to a handle 10 of the hair cutter 1. More particularly, the hair cutter 1 may include an elongated handle 10 accommodating electronic and/or electric components such as a control unit, an electric drive motor 30 or a magnetic drive motor, and a drive train for transmitting the driving action of the motor to the cutter system 3 at the cutter head 2 which cutter head 2 may be positioned at one end of the elongated handle 10, cf. FIG. 1.

The cutter system 3 may include one or more shear foil cutters 4 for short stubbles and/or one or more comb-like cutter units 5 for longer stubbles or problem hair, wherein, for example, the cutter head 2 may have two elongated, comb-like long hair cutters 5 positioned between a pair of shear foil cutters 4, or, in the alternative, at outer edge portions of such a shear foil cutters.

As shown by FIG. 1, the cutter head 2 may include elongated cutter units with cooperating cutter elements which may reciprocate relative to each other along a linear path defining driving axis 20 so as to affect the cutting action by passing over each other. On the other hand, the cutter head 2 also may include rounded or circular cutter units with cooperating cutter elements rotating relative to each other to affect the cutting action which is basically similar to reciprocating cutting elements as radially extending teeth and/or a disk-like shear foil cooperating with a disk-like blade element, when rotating and/or rotatorily oscillating, pass over each other, thereby effecting the cutting action.

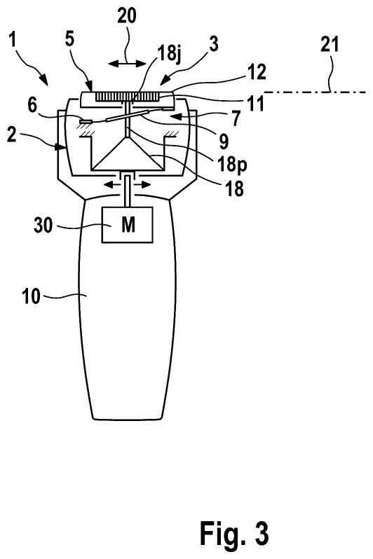

As shown by FIG. 3, the drive system may include a motor 30 the shaft of which may rotate an eccentric drive pin which is received between the channel-like contours of a driver 18 of, for example an oscillating bridge which is connected to one or more of the cutting units 4 and 5 which is/are caused to reciprocate due to the engagement of the rotating eccentric drive pin with the contours of said driver 18.

As shown by the figures, the cooperating cutting elements 11, 12 of the long hair cutters 5 basically may have—at least roughly—a plate-shaped configuration, wherein each cutting element may include one or more rows of cutting teeth. The cutting elements may be supported and positioned with their flat sides lying onto one another, so the cutting teeth of the cutting elements may touch each other back to back like the blades of a scissor.

In addition to such comb-like cutter units 5, the cutter units 4 of the shear foil type may include a shear foil 12 provided with at least one field of cutting perforations and defining a skin contact surface of the cutter unit and a blade element having a plurality of cutting blades 11 moving under said shear foil to cooperate with the perforations thereof. The shear foil 12 may be a stationary cutter element, whereas the cutting blades may be drivable cutter elements driven via the aforementioned driver 18 by motor 30 to reciprocate along driving axis 20.

Also the aforementioned long hair or comb-like cutter unit 5, more particularly the cutter elements 11 and 12 may be driven relative to each other along such driving axis 20.

Such driving axis 20 may extend basically parallel to the skin contact surface 21 and substantially parallel to the longitudinal axis of the substantially elongated cutter units 4, 5 to allow for reciprocating of the elongated cutter elements 11, 12 relative to each other.

Said cutter head 2 is attached to the handle 10, wherein the cutter head 2 may be slewably supported about a swiveling axis and about a tilting axis which swiveling and tilting axes may extend substantially perpendicular to each other and perpendicular to a longitudinal handle axis of the handle 10.

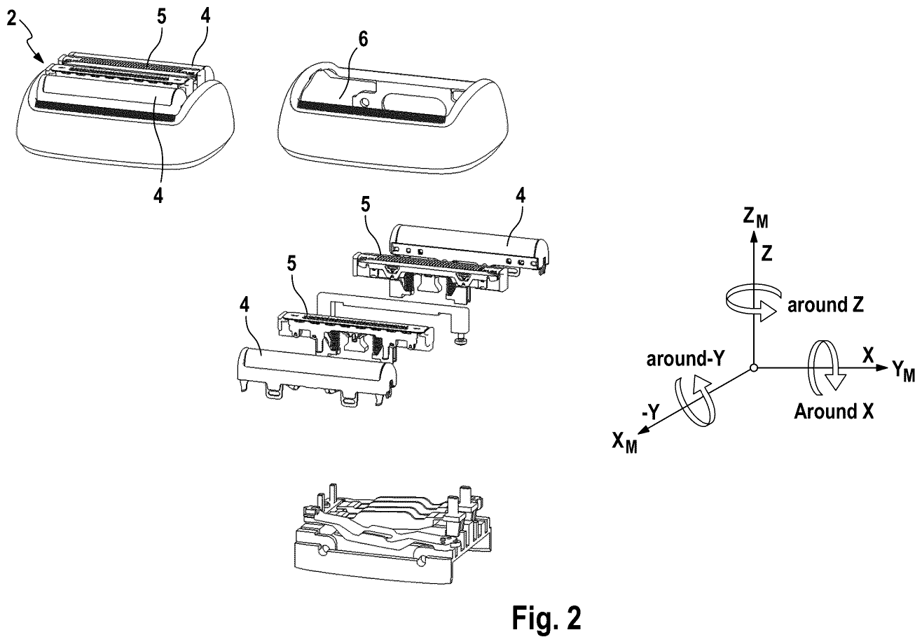

In addition, or in the alternative to such tilting and/or swiveling of the cutter head 2 in its entirety, the aforementioned cutter units 4, 5 are suspended movably relative to a cutter head frame 6 so as to allow for micro-diving and micro-tilting of the cutter head units 4 relative to the cutter head frame 6 and relative to each other. More particularly, each cutter unit 4, 5 may individually dive along a diving axis z which may extend substantially perpendicular to the skin contact surface 21, cf. FIG. 2. Furthermore, each of the cutter units 4, 5 may individually tilt about a tilt axis y which extends substantially perpendicular to the aforementioned diving axis z and thus, substantially parallel to the skin contact surface 21 and at the same time, substantially perpendicular to a main axis of the corresponding cutter unit which main axis may be a longitudinal axis of the cutter unit when such cutter unit has an elongated shape, cf. FIGS. 1, 2 and 3.

When considering a main axis 40 of the cutter head 2, cf. FIG. 1 the tilting axis y may extend perpendicular to such main axis 40 and substantially parallel to the skin contact surface 21. Such main axis 40 may extend in parallel to the longer side edges of the cutter head 2 and/or in parallel with a longitudinal axis of the elongated cutter elements 4, 5 and/or substantially perpendicular to the longitudinal handle axis of the handle 2. As can be seen from FIG. 1, the cutter head 2 may have a—roughly speaking—substantially rectangular plate- or block-like shape with a pair of longer side edges arranged on opposite sides of the functional or skin-contact surface 13 which is facing away from handle 2. The dive axis z may extend substantially perpendicular to the skin contact surface 21.

To allow for such micro-diving and micro-tilting of the cutter units 4, 5 relative to the cutter head 2, an elastic support structure 7 including a spring mechanism 8 is provided to elastically support each of the cutter units 4, 5 at the cutter head frame 6.

The spring mechanism 8 of said support structure 7 includes a leaf spring 9 for each of the cutter units 4, 5.

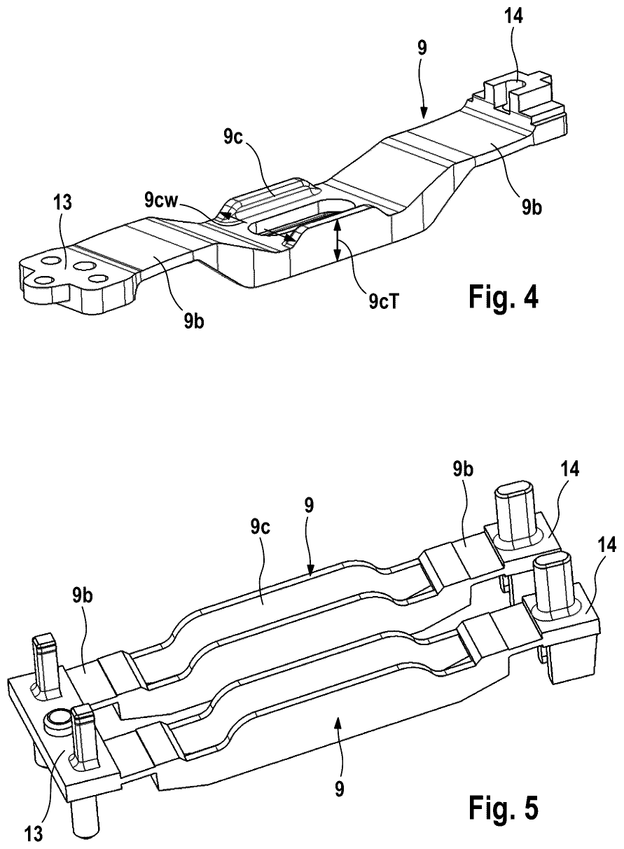

Such leaf spring may have an elongated, substantially bar-shaped or plate-like configuration, cf. for example FIG. 4 and FIG. 5, wherein FIG. 4 shows a leaf spring 9 for elastically suspending a shear foil-type cutter unit 4 and FIG. 5 shows two leaf springs 9 for elastically suspending the long hair cutter units 5. As shown by FIG. 5, a pair of leaf springs 9 may be connected to each other at one end thereof so both leaf springs 9 may have a common attachment point at the cutter head frame 6. Nevertheless, the leaf springs 9 may end and thus move individually to allow for individual self-adaption of the cutter unit supported thereby.

As shown by FIG. 2, each of the cutter units 4 and 5 may have its “own” leaf spring 9, wherein exactly one leaf spring 9 can be provided for each cutter unit 4, 5.

More particularly, said leaf spring 9 is rigidly attached, with one end portion 14, to a first end portion 4a, 5a or edge portion of said cutter unit 4, 5 and, with the other, opposite end portion 13, to said cutter head frame 6 at a spring support portion 17 thereof adjacent to a second end portion 4b, 5b or edge portion of the cutter unit 4, 5 opposite to the aforementioned first end portion 4a, 5a or edge portion thereof.

The leaf spring 9 may extend, from its fixation point at the cutter head frame 6, across or along the cutter unit 4, 5 to hold said cutter unit 4, 5 at an end/edge portion at the opposite side away from the leaf spring fixation point at the cutter head 2. Due to the rigid attachment at both end portions, the leaf spring 9 stabilizes the cutter unit with regard to driving motions of the drivable cutter element 11 relative to this stationary cutter element 12, whereas at the same time self-adaption movements are allowed by means of bending the leaf spring 9.

Thus, said leaf spring 9 may form a sort of double cantilever support structure for the cutter unit 4, 5, wherein the leaf spring 9 itself is cantilevered at the cutter head frame 6 and forms a cantilever, beam-like element projecting from the cutter head frame 6 and is fixedly attached thereto. On the other hand, the cutter unit 4, 5 is cantilevered at the opposite end portion of the leaf spring 9 and forms a sort of cantilevered element projecting from the leaf spring and fixedly attached thereto.

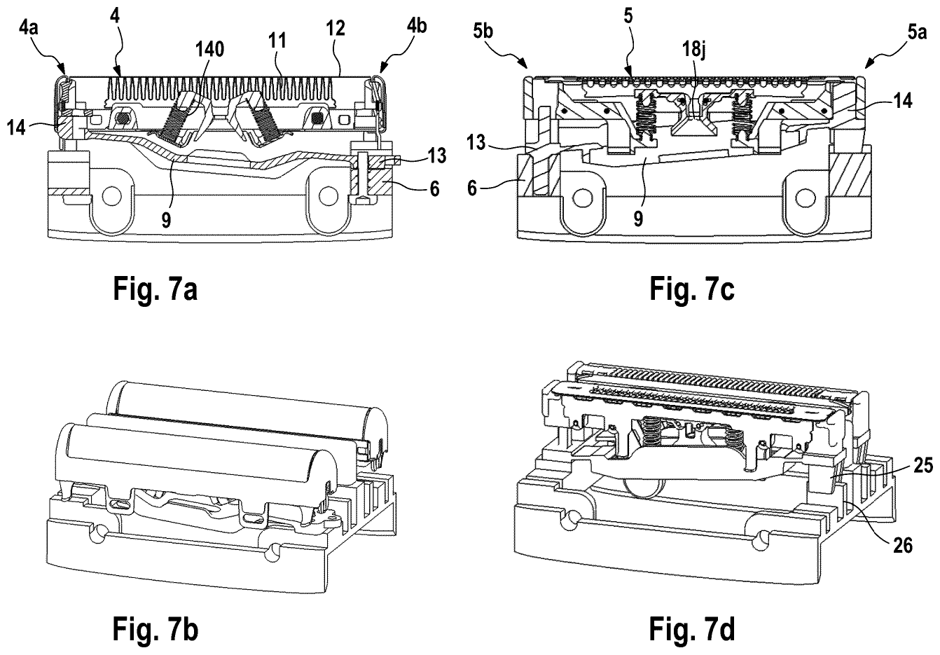

In a side view with a viewing axis parallel to a tilt axis y, cf. FIGS. 7a and 7c, the leaf spring 9 together with the cutter unit 4, 5 and the cutter head frame 6 attached to opposite ends 13, 14 of the leaf spring 9 may form a z-shaped support structure 7 allowing for diving and tilting of the cutter unit 4, 5 relative to the cutter head frame 6 along diving axis z and about tilt axis y due to elastic bending of the leaf spring 9, whereas said leaf spring may substantially rigidly hold the cutter unit in the direction of driving axis 20, i.e. perpendicular to the diving axis and to the tilt axis, thereby increasing driving efficiency.

The support structure 7, and more particularly the spring mechanism 8 thereof, can be an asymmetric one, wherein only one leaf spring 9 may be provided, as shown by the figures, so that only one end portion 4a, 5a or edge portion of the cutter unit 4, 5 is mounted to a leaf spring 9 and/or elastically held by a spring.

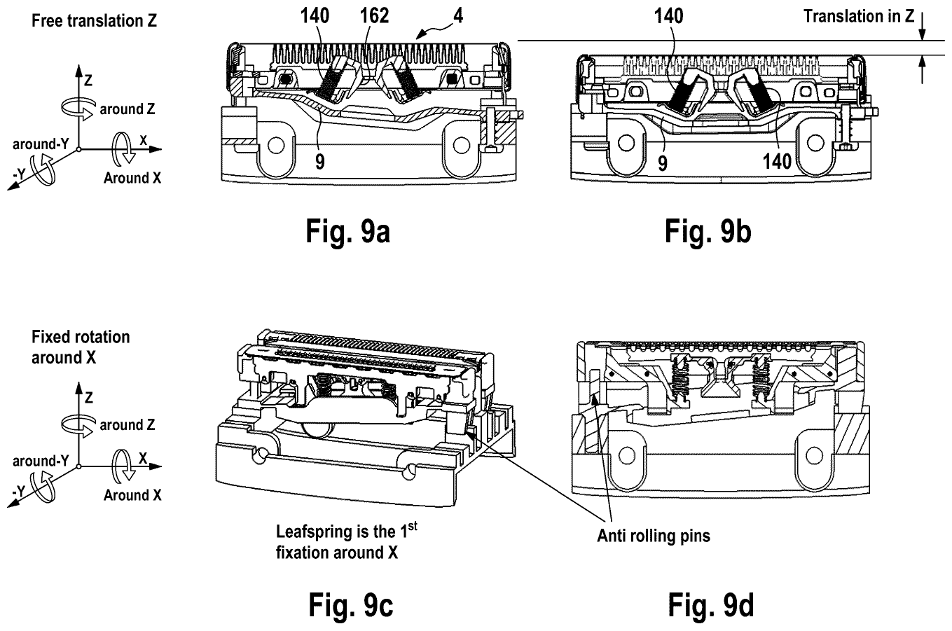

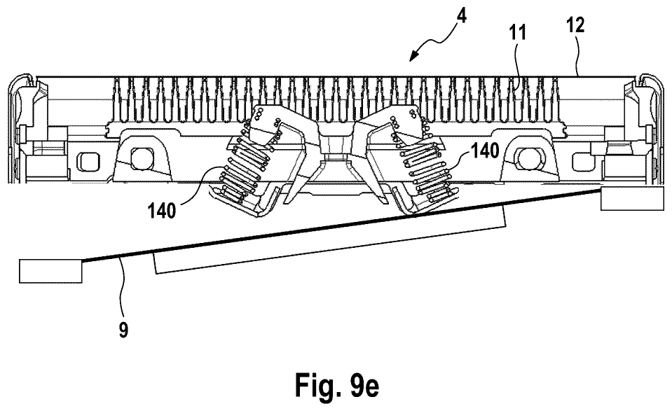

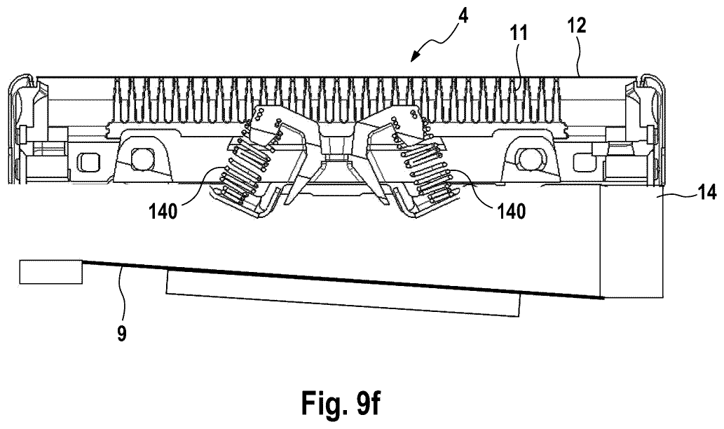

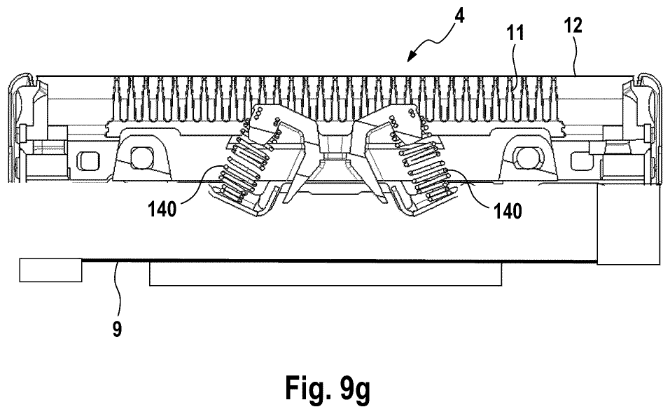

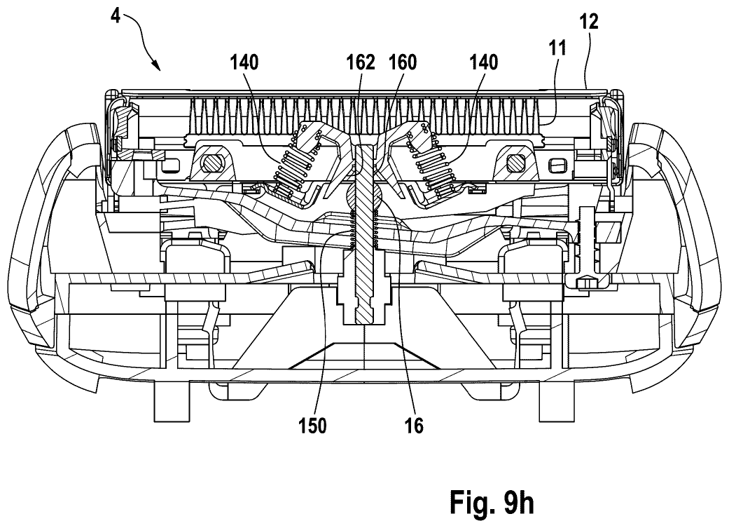

Despite such eccentric attachment of the leaf spring 9 to the cutter unit 4, 5 and the asymmetric layout of the spring mechanism, the elastic support structure of the at least one cutter unit nevertheless may be configured to provide for a symmetric self-adaption, in particular symmetric micro diving and/or micro tilting. The leaf spring 9 may provide for the same tilt resistance and/or same dive resistance for both right and left cutter unit portions 4a and 4b, and 5a and 5b. More particularly, the leaf spring 9 may be configured such that the cutter unit 4, 5, despite the eccentric attachment of the leaf spring to the cutter unit, dives along a diving axis without tilting about a tilt axis when the cutter unit is subject to skin contact pressure represented by a resultant skin contact force going through the center of the cutter unit. In other words, when a skin contact force is supplied to the center of the skin contact surface of the cutter unit, the cutter unit does not tilt to the left side or to the right side, but dives translationally or uniformly at both ends, i.e. opposite end portions of the cutter unit dive the same distance, cf. FIG. 9b versus non diving status FIG. 9a.

Since self-adaption movements of the cutter unit 4, 5 relative to the cutter head frame 6 go along with bending of the leaf spring 9, the bending characteristic of the leaf spring 9 may be configured such that the response of the cutter unit 4, 5 to skin contact pressure in terms of micro diving and/or micro tilting movements is symmetric. When the resultant skin contact force goes through the center of cutter unit 4, 5, the cutter unit 4, 5 dives translationally without tilting.

When the resultant skin contact force goes through a right side portion of the cutter unit 4, 5, the cutter unit may dive and tilt clockwise or only tilt clockwise. On the other hand, when the resultant skin contact force goes through a left side portion of the cutter unit 4, 5, there may be diving and counter-clockwise tilting or only counter-clockwise tilting.

The leaf spring 9 may have bending portions 9b adjacent to the end portions 13, 14 of the leaf spring which are attached to the cutter head 2 and the cutter unit 4, 5, respectively, wherein said bending portions 9b may provide for substantially identical bending stiffnesses and have substantially the same length. More particularly, such bending portions 9b may be arranged symmetrical and may provide for identical bending characteristics of the leaf spring 9 in the leaf spring region neighboring the cutter unit 4, 5 and/or the cutter unit attachment point on the one hand and neighboring the cutter head 2 and/or cutter head attachment point on the other hand.

Between such bending portions 9b adjacent to the leaf spring attachment points, the leaf spring 9 may include a center portion 9c connecting said bending portions 9b and configured to have a more rigid characteristic than the bending portions 9b.

More particularly, said center portion 9c of the leaf spring 9 may have a center thickness 9ct larger than the thicknesses of the bending portions 9b. In addition or in the alternative to such increased center thickness, the center portion may have a center width 9cw which is larger than the width of the bending portions of the leaf spring, cf. FIG. 4.

Due to increased center thickness and/or increased center width, the center portion 9c is significantly more rigid and/or stiffer than the bending portions s9b o bending of the leaf spring 9 due to skin contact pressure of the cutter unit occurs at well-defined portions and/or positions so micro diving and/or micro tilting of the cutter unit 4, 5 due to bending of the leaf spring 9 is well-controlled.

To increase bending stiffness of the center portion 9c, one or more reinforcement ribs may be provided at such center portion 9c to increase thickness and/or width of said center portion.

So as to have a soft and resilient suspension characteristic with regard to the desired self-adaption movements of the cutter unit 4, 5 and, at the same time, a rigid and stiff support characteristic with regard to the direction of driving movements of the drivable and stationary cutter elements 11, 12 relative to each other on the other hand, the leaf spring 9 may be inclined relative to the skin contact surface 21 of the cutter unit 4, 5 and/or to the driving axis 20 along which the cutter elements reciprocate or move relative to each other, at a relatively small angle α of inclination which, in some diving/tilting position, and/or in a starting or home position, even may become zero. More particularly, when the cutter unit has not yet dived and/or is in its home or neutral position subject to zero skin contact forces, the leaf spring 9, with its longitudinal axis, and/or a virtual connection line going through the end portions 13, 14 of the leaf spring 9 may extend parallel to or at an acute angle to a virtual plane perpendicular to the diving axis and/or parallel to the skin contact surface 21 of the cutter head 2, wherein such acute angle α may be less than 30° or less than 20° or less than 10°, when the cutter unit 4, 5 is in its sort of resting position when no skin contact pressure is applied to the cutter unit.

As can be seen from a comparison of FIGS. 9a, 9b with FIGS. 9e, 9f, the leaf spring may be inclined to said virtual plane at a positive acute angle or at a negative acute angle α. More particularly, FIG. 9e shows that the connection point of the leaf spring 9 to the cutter unit 4, 5 may be positioned higher than the connection point of the leaf spring 9 to the cutter head frame, when height is considered the direction perpendicular to the skin contact surface 21. On the other hand, as shown by FIG. 9f, the leaf spring's connection point to the cutter unit 4, 5 may be positioned lower than the leaf spring's connection point to the cutter head frame, in the alternative to FIG. 9e, when the cutter unit is in its home position not yet subject to skin contact pressure. A sort of intermediate configuration is shown by FIG. 9g illustrating that the leaf spring 9 may extend substantially parallel to the skin contact surface 21 when the cutter unit is in its neutral position subject to zero skin contact pressure. In other words, the leaf spring's connection points to the cutter unit 4, 5 on the one hand and to the cutter head frame on the other hand, may be arranged at substantially the same height, cf. FIG. 9g.

The leaf spring 9 may have a substantially straight longitudinal axis, cf. FIGS. 4 and 5, so as to have a stiff and rigid configuration of the leaf spring 9 with regard to driving movements, wherein such straight longitudinal axis may extend almost parallel to or only slightly inclined relative to the driving axis 20 so the leaf spring 9 shows significant resistance against reaction forces implied by the driving movements of the cutter elements.

The driving axis of the cutter elements may extend substantially parallel to the skin contact surface 21, in particular when the cutter elements have an elongated configuration, wherein the cutter elements may reciprocate relative to each other along such driving axis.

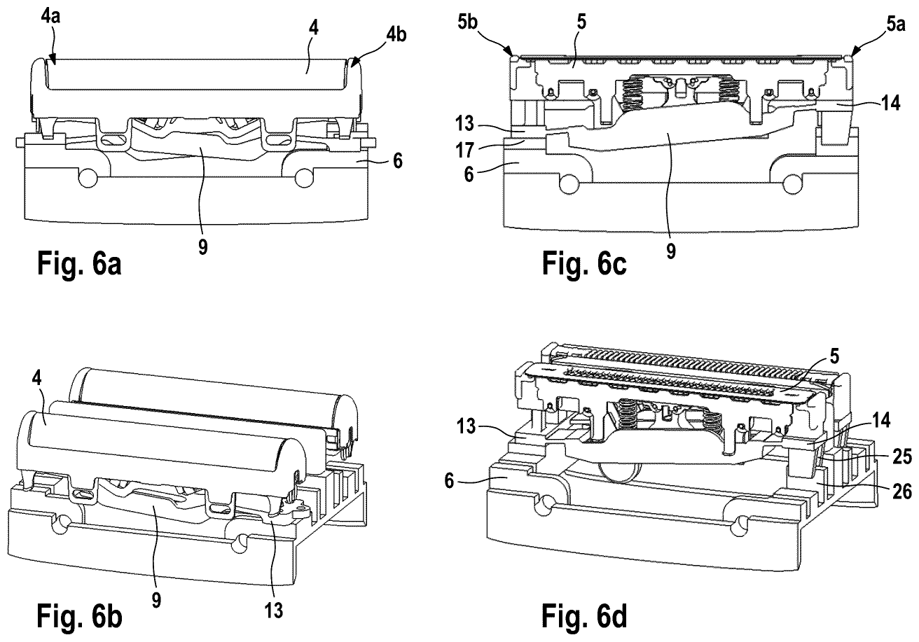

So as to help the leaf spring 9 in holding the cutter unit 4, 5 in a stiff and rigid way with regard to driving forces, the leaf spring 9 may be arranged in a common plane containing the driving axis and the longitudinal leaf spring axis, cf. FIG. 6 a-d and 7 a-d. More particularly, although the longitudinal axis of the leaf spring may extend in such virtual plane, the leaf spring, with its width direction, may be arranged substantially perpendicular to the virtual plane so that movements of the leaf spring due to bending thereof occur substantially parallel to such virtual plane.

As can be seen from FIGS. 5 and 7a-d, the leaf spring 9 does not have to provide for biasing pressure or biasing forces urging the reciprocating cutting elements 11, 12 onto each other, but separate biasing means such as one or more springs 140 such as screw springs may be provided for pressing the cooperating stationary and drivable cutter elements 11, 12 onto each other.

For example, one or more springs 140 such as screw springs may be active between the drivable cutter element 11 and the stationary cutter element 12 to urge them towards each other. For example, said springs 40 may be supported at a shear foil carrier or a stationary cutter support frame on the one hand and apply a spring force onto the drivable cutter element 11 so as to urge the drivable cutter element 11 onto the stationary cutter element 12.

Thus, the aforementioned leaf spring 9 of the spring mechanism 8 of the support structure 7 may exclusively serve the function to adjust the resistance and/or restoring and/or elasticity of the cutter units 4, 5 with regard to the micro-diving and micro-tilting or more generally, the desired self-adaption movements. In other words, the driving resistance in terms of friction of the movable and stationary cutter elements relative to each other, may be independent of the leaf spring, wherein such driving resistance in terms of friction may depend on the contact pressure between the movable and stationary cutter elements which may be controlled by the one or more springs 140 shown by FIGS. 5, 7a-7d and 9a-h.

Furthermore, when providing for separate biasing means or a separate spring device for achieving the desired cutting element pressure in terms of urging the surfaces of cooperating cutter elements onto each other, it is no longer necessary, but still possible, to elastically urge the transmitter against the drivable cutter element 11. More particularly, the drive pin 18p of transmitter 18, cf. FIG. 3, does not have to be elastically urged towards the drivable cutter element 11, but may be received in a transmission joint 18j of the drivable cutter unit 11 in an axially loose way. More particularly, the transmission joint 18j may be configured to only transmit forces and/or torque along or about the driving axis 20, whereas no forces or torques are transmitted in directions perpendicular thereto. In particular, no forces need to be transmitted in the longitudinal direction of the drive pin 18p of drive bridge 18.

Nevertheless, it should be mentioned that the drive joint 18j still may be configured to transmit biasing forces urging the drivable cutter unit 11 against the stationary cutter element 12. For example, the transmitter joint 18p may include a cone-shaped drive pin and a cone-shaped recess receiving the drive pin, or a spherical drive pin received in a spherical recess, wherein such drive pin may be urged in a direction perpendicular to the skin contact surface 21 to press the drivable cutter element 11 towards the stationary cutter element 12. In such configuration, the leaf spring 9 may be configured to apply a biasing force onto the stationary cutter element 12 going into the opposite direction, for example the leaf spring 9 may urge the stationary cutter element 12 towards the handle 10 to balance the drive pin biasing to some extent. Thus, a light-footed self-adaption with very little skin contact pressure may be achieved.

According to an aspect, diving resistance may be controlled exclusively by the leaf spring 9, in particular when there is no biasing of the aforementioned drive joint.

However, according to another aspect, there may be at least one further spring 150 for controlling diving of the cutter unit 4, 5 and providing for a restoring force counteracting such diving in addition to the leaf spring 9. As can be seen from FIG. 9h, such additional spring 150 for controlling diving, may be configured to be inactive in the cutter unit's neutral or home position when there is no skin contact pressure, and/or inactive over a first portion of the diving path out of said neutral or home position. In other words, the additional spring 150 may be inactive as long as the cutter unit 4, 5 has not yet covered a certain diving distance.

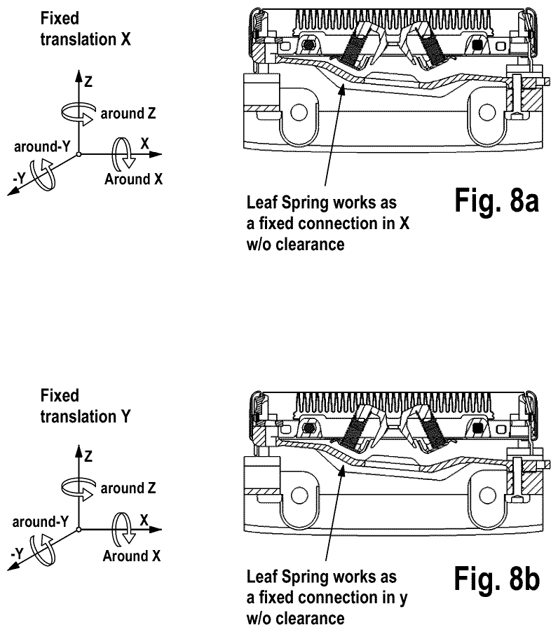

FIGS. 8a-b illustrate the removal of play by the leaf spring in x and y direction due to the 3D rigidity of the leaf spring and due to the fixations of the leaf spring at its end portions.

As can be seen from FIG. 9h, there may be some play or distance between spring 150 and cutter unit 4, 5 when the cutter unit is in its neutral or home position. More particularly, such play or distance 160 may be provided between a contact element 161 which is provided at one end of the spring 150 and is configured to contact the cutter unit 4, 5. Such contact element 161 may have a spherical shape or at least a partly spherical contact surface to avoid influence of the spring 150 on to tilting movements and/or to allow control of tilting movements exclusively by the leaf spring 9.

More particularly, the aforementioned contact element 161 and its counterpart 162 at the cutter unit 4, 5 may be configured to transmit forces in a direction substantially perpendicular to the skin contact surface, but no torques and no forces trying to tilt or pivot the cutter unit 4, 5.

As can be seen from FIG. 9h, the additional spring 150 may become active for a second or last portion of the diving path. When the cutter unit 4, 5 has dived a certain distance under exclusive control of the leaf spring 9, the contact element 161 gets into engagement with the cutter unit 4, 5, in particular the cone-shaped engagement element 162 so the cutter unit needs to deflect not only the leaf spring 9, but also the additional spring 150 to further dive.

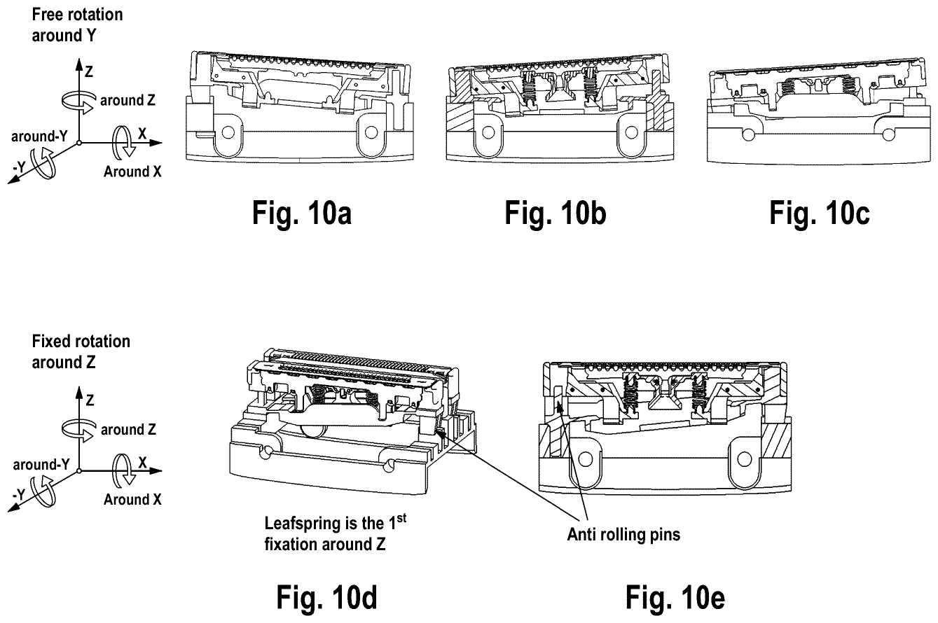

FIGS. 10a-10e show the leaf spring support structure, wherein partial views 10a, 10b and 10c illustrate tilting of the cutter unit about tilt axis y by means of elastically bending the leaf spring under different tilting angles. The tilting may be caused by asymmetric forces on only one side of the cutting unit and may be different for each cutting unit in the shaver head depending from the skin contour to be shaved. Partial views 10d and 10e illustrate rigidity of the leaf spring support structure against rotatory movements of the cutter units about diving axes z, said support structure having anti-rolling pins preventing such rotation. It is to be noted that the anti-rolling pins and above described further cutter unit guiding means are provided in addition to the functionality of the leaf spring structure providing already that limitation to the degree of freedom to move for the cutting unit.

Thus, the restoring characteristic of the spring mechanism 8 with regard to the diving adjustments may have a two-step configuration. For an initial portion of the diving path, a linear restoring characteristic may be provided by the leaf spring 9 only, whereas for a final portion of the diving path a linear, but stronger restoring characteristic may be provided by the leaf spring 9 together with the additional spring 150.

Irrespective of the transmitter architecture, the leaf spring 9 may be configured to allow for light-footed self-adaption in terms of micro-tilting and micro-diving with very little skin contact pressure.

In addition to the aforementioned micro-adapting movements of cutter units 4,5 relative to the cutter head 2, the entire cutter head 2 may move relative to the handle 2.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Hair cutter such as electric shaver and/or electric trimmer, comprising a handle and a cutter head attached to said handle, and at least one cutter unit including a pair of drivable and stationary cutter elements cooperating with each other, said cutter unit being adjustably supported by means of a support structure including a spring mechanism to allow for elastic self-adaption of the cutter unit to the skin contour in terms of diving along a diving axis (z) extending perpendicular to a skin contact surface of the cutter unit and/or tilting of the cutter unit relative to a cutter head frame about a tilt axis (y) extending perpendicular to said dive axis (z), said spring mechanism including at least one elongated leaf spring, wherein said leaf spring is rigidly attached, with one end portion, to a first end portion or edge portion of said cutter unit and, with another end portion, to said cutter head frame at a spring support portion thereof adjacent to a second end portion or edge portion of the cutter unit opposite to the first end portion or edge portion thereof.

2. Hair cutter according to claim 1, wherein said support structure forms an eccentric, cantilever-type suspension holding the cutter unit elastically with regard to the diving and/or tilting self-adaption movements of the cutter unit and rigidly holding said cutter unit with regard to driving movements of the drivable and stationary cutter elements of the cutter unit relative to each other, wherein said leaf spring forms an elongated, cantilevered element projecting from and fixedly attached to the cutter head frame and wherein the cutter unit is held by the leaf spring in a cantilevered fashion with the cutter unit projecting from and fixedly attached to said leaf spring.

3. Hair cutter according to claim 2, wherein a driving axis along which the drivable and stationary cutter elements are movable relative to each other, a longitudinal axis of the leaf spring and a main axis of the cutter head frame extending parallel to a skin contact surface of the cutter head, together define a Z-shaped arrangement which is elastically deformable by means of bending the leaf spring.

4. Hair cutter according to claim 1, wherein said leaf spring includes a center portion and a pair of bending portions between said center portion and said end portions or edge portions of the leaf spring rigidly attached to said cutter unit and said cutter head frame, respectively, wherein said center portion has a rigidity larger than the rigidity of said bending portions.

5. Hair cutter according to claim 4, wherein said center portion has a center thickness larger than the thicknesses of said bending portions and/or a center width larger than the width of said bending portions of the leaf spring.

6. Hair cutter according to claim 1, wherein said leaf spring has a bending characteristic configured such that the cutter unit, despite the eccentric attachment of the leaf spring to the cutter unit, dives along said diving axis (z) without tilting about said tilt axis (y), when the cutter unit is subject to skin contact pressure with its resultant skin contact force going through the center of the cutter unit.

7. Hair cutter according to claim 6, wherein said leaf spring having bending portions adjacent to the end portions of the leaf spring attached to the cutter head and the cutter unit, respectively, wherein said bending portions provide for substantially identical bending stiffnesses and have substantially the same length, wherein said bending portions are separated from each other by a leaf spring center portion having a bending stiffness significantly larger than the bending stiffnesses of the bending portions.

8. Hair cutter according to claim 1, wherein, when said cutter unit is in a neutral position with zero forces onto the skin contact surface, said leaf spring, with its longitudinal axis, and/or a virtual connection line going through the end portions of the leaf spring, extend at an acute angle (α) to a virtual plane perpendicular to the diving axis (z) and/or parallel to the skin contact surface of the cutter head, said acute angle (α) being less than about 30° or less than about 20° or less than about 10°.

9. Hair cutter according to claim 1, wherein said leaf spring is arranged in a virtual plane extending substantially perpendicular to the skin contact surface of the cutter head and containing a driving axis along with the cutter elements of the cutter unit are movable relative to each other, wherein said leaf spring, with its width dimension, extends perpendicular to said virtual plane so that movements of the leaf spring due to bending thereof are substantially parallel to said virtual plane.

10. Hair cutter according to claim 1, wherein said leaf spring, with its longitudinal axis, extends at an acute angle (α) to the driving axis of the cutter unit along which the drivable and stationary cutter elements thereof are movable relative to each other, wherein said acute angle (α) is less than about 30° or less than about 10°.

11. Hair cutter according to claim 1, wherein one of the following:
(i) said at least one cutter unit has an elongated, beam-shaped configuration defining a longitudinal axis (x), wherein said first and second end portions or edge portions are spaced apart from each other along said longitudinal axis (x) and/or are the outer most portions of said cutter unit along said longitudinal axis (x),
(ii) said at least one cutter unit has a circular or cylindrical configuration having an axis (z) of rotational symmetry, wherein said first and second end portions or edge portions of said cutter unit are opposed to each other on opposite sides of said axis (z) of rotational symmetry and/or are spaced apart from each other along a virtual line perpendicular to said axis (z) of rotational symmetry, and
(iii) said first and second end portions of said cutter unit define a maximum extension of said cutter unit along an axis parallel to said skin contact surface and/or are spaced from each other along an axis parallel to said skin contact surface.

12. Hair cutter according to claim 1, wherein said leaf spring is attached to the stationary cutter element.

13. Hair cutter according to claim 1, wherein the spring mechanism of the support structure includes only one leaf spring and/or only one spring elastically holding the cutter unit at the cutter head frame.

14. Hair cutter according to claim 1, wherein a drivetrain for driving the cutter elements of the at least one cutter unit relative to each other from a motor, includes a transmitter joint providing for a freedom of motion in an axial direction perpendicular to the contact surfaces of the cooperating cutter elements at which said cutter elements contact each other, thereby avoiding biasing of the cooperating cutter elements against each other from the drivetrain via the transmission joint, wherein driving resistance of the cutter unit is controlled independently by the leaf spring and/or controlled exclusively by a further spring.

15. Hair cutter according to claim 1, wherein a transmission train for driving the cooperating cutter elements of said at least one cutter unit includes a spring-biased transmission joint applying biasing forces onto the drivable cutter element to bias said drivable cutter element against the stationary cutter element, wherein the leaf spring is configured to apply a biasing force onto the stationary cutter element counteracting said biasing force from the transmission joint.

16. Hair cutter according to claim 1, wherein the at least one cutter unit includes sliding guide contours engaging with and/or cooperating with cutter head sliding guide contours to allow for diving and/or tilting of the cutter unit relative to the cutter head frame, but preventing the cutter unit from swiveling relative to the cutter head frame about a swivel axis (x) perpendicular to the dive axis (z) and the tilt axis (y), wherein said sliding guide contours are configured freely movable relative to each other in a plane containing the diving axis (z) and perpendicular to the tilt axis (y) so the cutter unit is held against movements along the driving axis only by the leaf spring.

17. Hair cutter according to claim 1, wherein the cutter head is movably supported onto said handle by means of a support structure configured to allow rotatory self-adjustment of the cutter head to a skin contour, wherein said support structure provides for a swivel axis and/or a tilting axis for swiveling and/or tilting of the cutter head relative to the handle head portion, wherein such swivel and tilt axes extend perpendicular to each other and substantially parallel to a skin contact surface of a cutter head.
